(19) United States
(12) Patent Application Publication
(10) Pub. No.: US 2019/0079668 A1
(43) Pub. Date: Mar. 14, 2019

(54) USER INTERFACES FOR KEYBOARDS

(71) Applicant: Ashwin P Rao, Kirkland, WA (US)

(72) Inventor: Ashwin P Rao, Kirkland, WA (US)

(21) Appl. No.: 16/024,099

(22) Filed: Jun. 29, 2018

Related U.S. Application Data
(60) Provisional application No. 62/526,473, filed on Jun. 29, 2017.

(51) Int. Cl. G06F 3/0488; G06F 3/023

(52) U.S. Cl. CPC G06F 3/04886; G06F 3/0237

(57) ABSTRACT

The disclosure describes keyboard user-interfaces UIs. A system including a modified keyboard having fewer keys than a standard qwerty keyboard is disclosed. The modified keyboard appears on a display of the system. The system also including a keyboard UI module for processing inputs from the modified keyboard, wherein the keyboard UI module implements directional double taps for specified symbols, swipe gestures for changing modes that are displayed as the modified keyboard and for incorporating special keys of the modified keyboard, and status indicator changes using color coding schemes on the display. The keyboard UI module for implements wavetags for blind input of symbols and shortcuts on the modified keyboard.

### CROSS-REFERENCE TO RELATED APPLICATIONS

This patent application claims priority to U.S. Provisional Patent Application No. 62/526,473 filed Jun. 29, 2017, which is incorporated herein by reference in its entirety.

### FIELD OF THE INVENTION

The invention relates to User Interfaces (UIs) for keyboards.

### BACKGROUND

The problem of designing UIs for keyboards of computers including PCs, laptops, cellular phones, tablets, smart watches, and smart glasses, is of specific importance in document production and several mobile and internet applications. Typically, a keyboard is accompanied with several functions, each of which may be viewed as having a separate UI.

One keyboard function is the entry of most frequently used symbols, namely comma and period. Existing UIs typically address this by placing comma and period keys on the left and right of the spacebar. This adds to the clutter of the main QWERTY keyboard screen. UIs that attempt to reduce clutter by removing the comma and period keys altogether, burden users to switch modes when inserting a comma and period. This UI lowers the user's overall typing throughput. Many UIs use double-tapping (the spacebar) to solve the problem, but they are only partially successful because they use the double-tap either for input of a comma or for the input of a period; but not for inputting both comma and period together.

Another keyboard function is changing of modes, namely changing between ABC, symbols, digits, emojis, dictation, and other modes. Most UIs for changing modes are based on a mixture of key-taps and key-long-presses. For example, the symbols and digits modes are combined into one mode which is then invoked by tapping the 123 key. The emoji mode is invoked by long-pressing the Return/Enter key. To change to the dictation mode, the user presses a dedicated dictation button or long-presses a key, such as the comma key, that has been mapped to the dictation function. These UIs for changing modes have the following problems: (1) they add clutter to the QWERTY keyboard screen; (2) they burden users to remember the different actions associated with the various mode changes; (3) they slow the overall typing throughput; and (4) they make the overall keyboard UI somewhat inconsistent.

Current keyboard UI techniques have a problem associated with the symbols mode in that the symbols are distributed across two screens. The second screen of the symbols is accessed by subsequently tapping a key of the form “=\<” in the first screen. Not only does this UI slow the symbol input, but it also requires users to remember which symbols are placed in which screen.

Current keyboard UI techniques also have a problem associated with the digits mode in that the digits mode is coupled along with the symbols mode. This results in a keyboard UI having small key sizes for digits, which requires digits to be entered slowly.

Finally, current keyboard UI techniques have a problem with the emoji and dictation modes. These UIs have the emoji and dictation modes detached from the rest of the UIs of the other modes. For example, the Del and return keys in these modes are located at different positions compared to other modes, which makes it confusing for the user.

Some functions that are always available on full-size keyboards are the special keys, namely, Control (Ctrl), Alt, Escape (Esc), Insert (Ins), Function (Fn), and directional (left, right, home, end) keys. Those familiar with the art will recognize that inclusion of these functions on a small keyboard will come at the expense of additional clutter to existing modes. Therefore, these keys are usually ignored on several keyboards found on mobile devices.

Other standard functions in keyboards are the Shift and Caps-Lock keys. Currently, keyboard UIs have small size keyboards that combine these standard functions into a single key and distinguish between the keys by detecting a press/long-press. The status of these keys (i.e., whether the shift key or the caps-lock is turned ON), is typically indicated by an LED light or using a change of case (i.e., lowercase or uppercase) of the letters. Unfortunately, when a user is typing fast, it is very difficult to register these indications. Therefore, the current keyboard UI techniques for handling shift-key and caps-lock-key causes false-alarms and continue to pose problems while typing.

Some keyboards boast a feature whereby users can create and use keyboard shortcuts. It has a UI wherein users need to go to settings (or some location which requires several steps to access), type the phrase, and type a shortcut for that phrase, to create the shortcut. To use the shortcut from within the keyboard, the user needs to type the shortcut and select the assigned phrase from the choice list. This keyboard UI has the following problems: 1) it takes multiple steps to create the shortcut; and 2) selection of the phrase (tagged by the shortcut) from the displayed choices is a slow process.

Finally, almost all prior-art keyboards UIs rely heavily on choice list-based UIs for typing. Those familiar with the art will recognize that selecting a desired choice from a list of choices require users to pause typing and lift their eyes to view the displayed choices, which in turn disrupts the overall flow of typing.

The present invention proposes new UIs to address all of the above problems.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates one embodiment of a keyboard UI providing directional-double-tap in accordance with the present application;

FIG. 2 illustrates one embodiment of a keyboard UI providing insertion of a period using a left-double-tap in accordance with the present application;

FIG. 3 illustrates one embodiment of a keyboard UI providing insertion of a comma using a right-double-tap in accordance with the present application;

FIG. 4 shows an embodiment of a keyboard UI providing f a directional-double-tap using existing key-codes in accordance with the present application;

FIG. 5 illustrates one embodiment of a keyboard UI providing SwipeFrom gestures in accordance with the present application;

FIG. 6 illustrates one embodiment of A keyboard UI providing variants of the SwipeFrom gesture in accordance with the present application;

FIG. 7 illustrates one embodiment of a keyboard UI providing SwipeFrom using key-press and key-release codes and locations in accordance with the present application;

FIG. 8 illustrates one embodiment of a keyboard UI providing SwipeFrom on a spacebar using hidden keys in accordance with the present application;

FIG. 9 illustrates one embodiment of a keyboard UI providing mode changes and special-keys support in accordance with the present application;

FIG. 10 illustrates one embodiment of a keyboard UI providing keyboard's Function (Fn) key support in accordance with the present application;

FIG. 11 illustrates one embodiment of a keyboard UI providing Left, Right, Home, and End keys support in accordance with the present application;

FIG. 12 illustrates one embodiment of a keyboard UI providing support for all 31 symbols in one screen in accordance with the present application;

FIG. 13 illustrates one embodiment of a keyboard UI for enabling larger digit screen in accordance with the present application;

FIG. 14 illustrates one embodiment of a keyboard UI for a better and consistent emoji screen in accordance with the present application;

FIG. 15 illustrates one embodiment of a keyboard UI for simpler and more consistent dictation screen in accordance with the present application;

FIG. 16 illustrates one embodiment of a keyboard UI for indicating shift-status using dark color for letter keys in accordance with the present application;

FIG. 17 illustrates one embodiment of a keyboard UI for indicating status of caps-lock using dark color for all keys in accordance with the present application;

FIG. 18 illustrates one embodiment of a keyboard UI for indicating speech-function status using light color for all letter keys in accordance with the present application;

FIG. 19 illustrates one embodiment of a keyboard UI for quick-and-easy input of digits in accordance with the present application;

FIG. 20 illustrates one embodiment of a keyboard UI for quick-and-easy input of emojis in accordance with the present application;

FIG. 21 illustrates one embodiment of a keyboard UI for quick-and-easy input of gif and mp3 format emojis in accordance with the present application;

FIG. 22 illustrates one embodiment of a keyboard UI for speak-and-touch mode in accordance with the present application;

FIG. 23 illustrates one embodiment of a keyboard UI for enhancing dictation UI using speak-and-touch in accordance with the present application;

FIG. 24 illustrates one embodiment of a keyboard UI for quick-and-easy input of digits and emojis using speech in accordance with the present application;

FIG. 25 illustrates one embodiment of a keyboard UI for prediction of partially typed words in accordance with the present application;

FIG. 26 illustrates one embodiment of method for predicting of partially typed words in accordance with the present application;

FIG. 27 illustrates one embodiment of a keyboard UI for speech-to-text in accordance with the present application;

FIG. 28 illustrates an embodiment of a keyboard UI for blind input of symbols using speech in accordance with the present application;

FIG. 29 illustrates one embodiment of a keyboard UI for using shortcuts or Wavetags in accordance with the present application;

FIG. 30 illustrates embodiments of a keyboard UI for creating Wavetags for mapping text in accordance with the present application;

FIG. 31 illustrates embodiments of keyboard UI for creating Wavetags for mapping actions in accordance with the present application;

FIG. 32 illustrates one embodiment of a keyboard UI providing keyboard function mappings in accordance with the present application;

FIG. 33 illustrates one embodiment of a keyboard UI providing a built-in tutorial in accordance with the present application; and

FIG. 34 is a functional block diagram representing a computing device for use in certain implementations of the disclosed embodiments or other embodiments of the present user-interface for keyboards in accordance with the present application.

### DETAILED DESCRIPTION OF THE PREFERRED EMBODIMENT

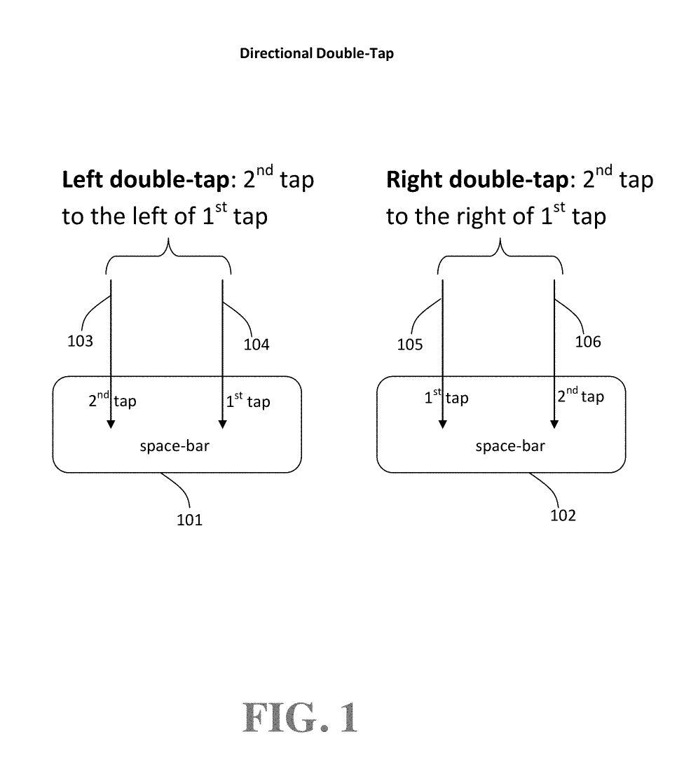

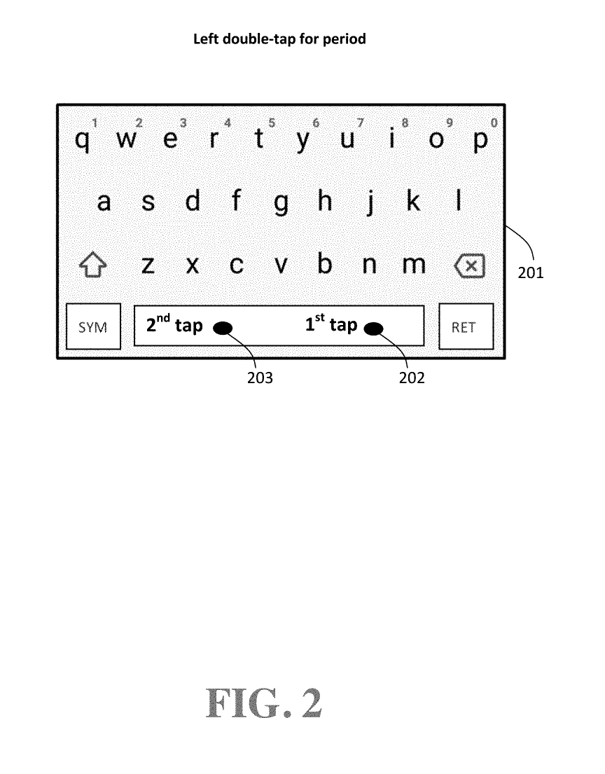

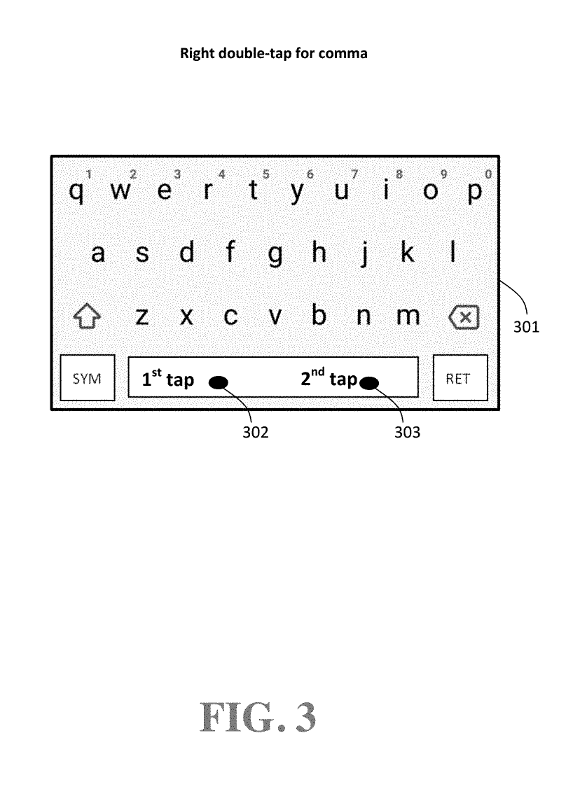

The present application proposes a keyboard UI that eliminates the need for comma and period keys; thus enabling the spacebar to be extra wide. The keyboard UI, dubbed “directional double-tap”, uses double-tapping but with an introduction of a directional element to it; so that both comma and period may be implemented using double-tap. As shown in FIG. 1, a left-double-tap is defined as an action carried out by first tapping the spacebar 101 as shown by action 104 and then once again tapping the spacebar 101 but this time to the left side of the first tap as shown by the action 103. Conversely, a right-double-tap occurs when the second tap 106 on space-bar 102 is on the right of the first tap 105. The actual tap locations may be configured as per convenience. FIGS. 2 and 3 show the insertion of period and comma respectively, on an actual keyboard, using a left-double-tap (202 followed by 203) and right-double-tap (302 followed by 303) respectively.

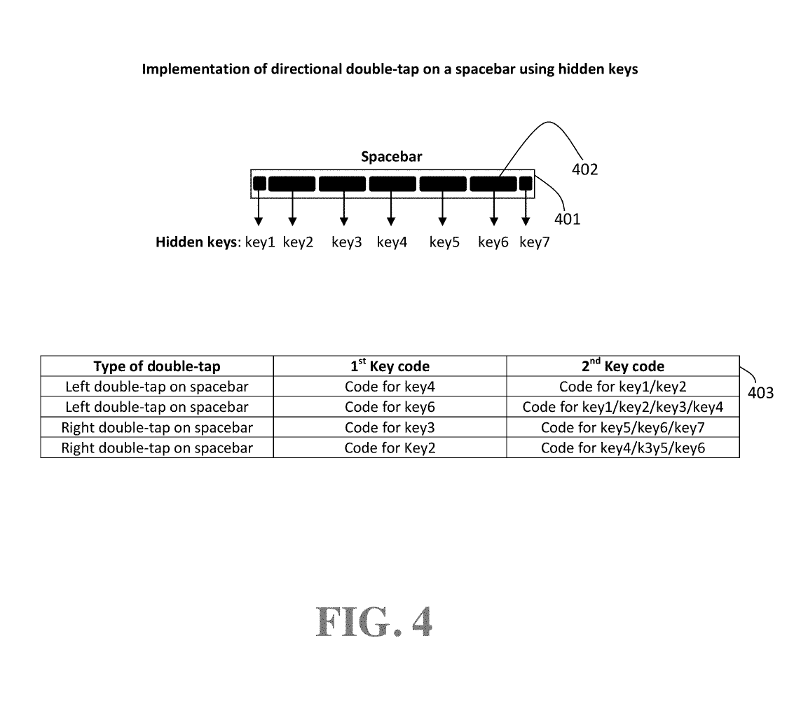

While directional double-tap may be implemented by tracking the location of screen taps, FIG. 4 shows an embodiment of implementing the directional double-tap on a space-bar 401 using existing keyboard key codes as shown in 403. Observe that the key immediately adjacent to the first key pressed is ignored so as to allow for ambiguous key presses by the user. For example, if key6, i.e. 402, is the first pressed key, then a left double-tap is valid only if the second key press is one of key1, key2, key3, or key4; and not key5.

Those familiar with art will appreciate that the directional double-tap can be extended to touch screens in general; and is not restricted only to keyboards. They can be implemented based on pressing or release of keys. Also, a time duration can be introduced as is usually done for traditional double-taps; so that if a user taps the spacebar and waits for a long time and once again taps the spacebar at a different location then it is not considered to be a directional double-tap. Further, the directions may be switched around so that left double-tap is used for comma and right double-tap for period. The reason for right and left double-taps for comma and period respectively is to enable an intuitive keyboard UI wherein the comma and period, which are usually placed on left and right of the spacebar respectively, may be simply treated as being in their usual locations but invisible. Those skilled in art will further appreciate that the directional double-taps may be replaced by directional swipe gestures on the spacebar. For example, a user starts a swipe from the spacebar 401 moving up and then returns to the spacebar such that the return position is on the right of the starting position. Finally, the directional double-taps may be mapped to actions instead of insertion of the comma and period symbols.

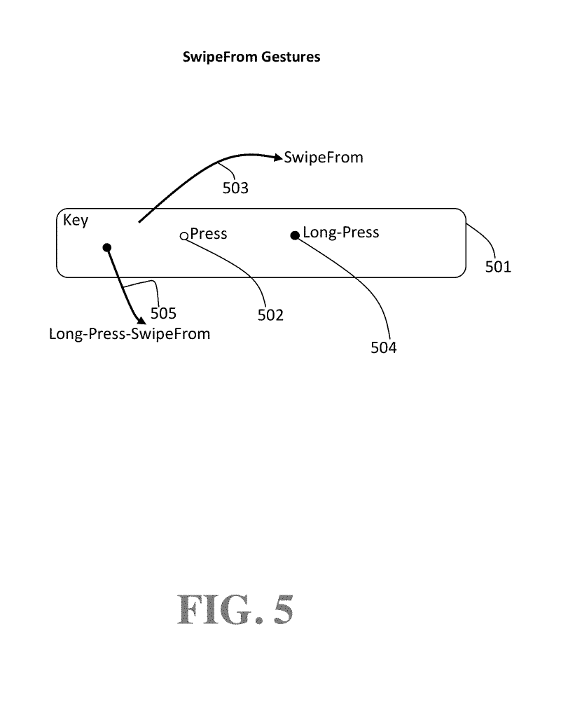

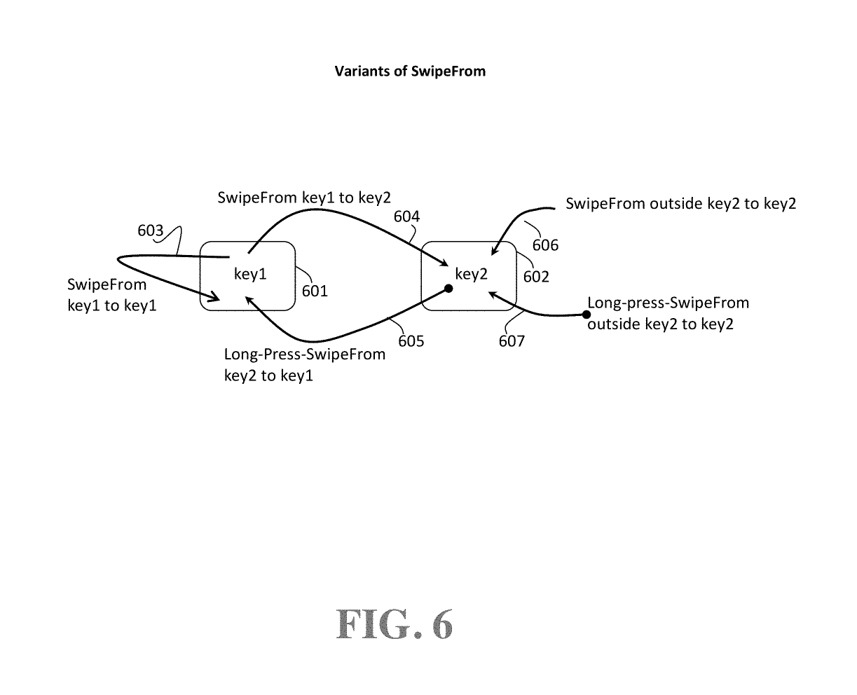

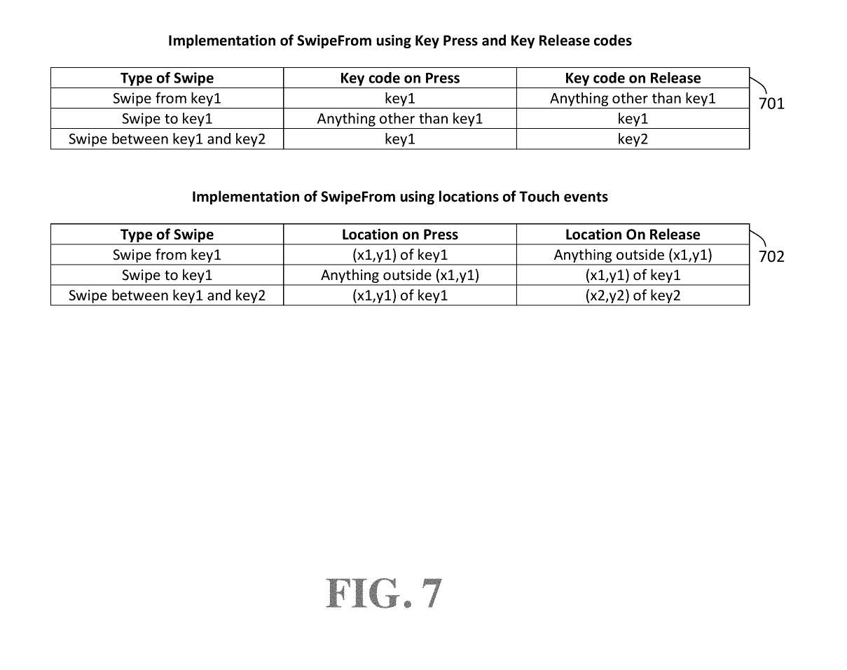

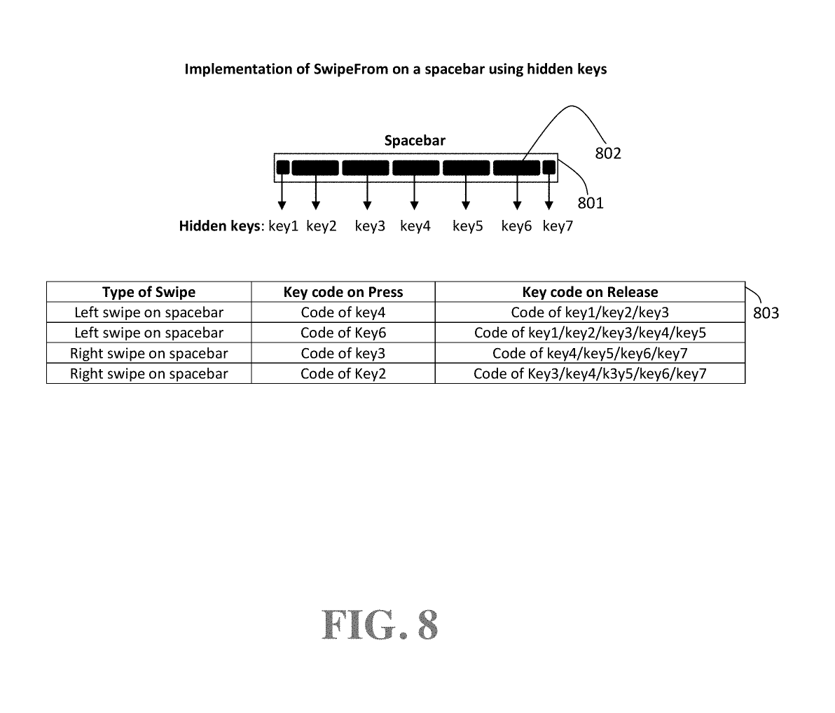

In FIG. 5 a keyboard UI dubbed “SwipeFrom” is shown as a gesture that extends the press 502 and long-press 504 on a key 501 using gestures 503 and 505, respectively. Observe that in these cases the SwipeFrom gesture is defined by its source key, as opposed to the conventional swipe gestures like Up, Down etc that are specified by their directions. FIG. 6 illustrates variants of the SwipeFrom gesture. Specifically, SwipeFrom 603 refers to swiping from the key 601 to form a loop back to the key 601; SwipeFrom 604 refers to swiping from key1 601 to key2 602; SwipeFrom 605 refers to swiping from key2 602 to key1 601; SwipeFrom 606 refers to swiping from anywhere outside of key2 602 to key2 602; and SwipeFrom 607 refers to long-pressing anywhere outside of key2 602 followed by swiping from to key2 602. The actual implementation of SwipeFrom gestures are shown in 701 and 702 of FIG. 7. Observe that the software implementation can be done using key-codes and/or key-locations of the start and/or end keys; in case of an extra wide key (e.g., the spacebar) the implementation may be done as shown in FIG. 8, using hidden keys, e.g. 802, of the space-bar 801 as shown in 803. Those familiar with art will recognize that other ways of detecting source and destination of gesture can also be used.

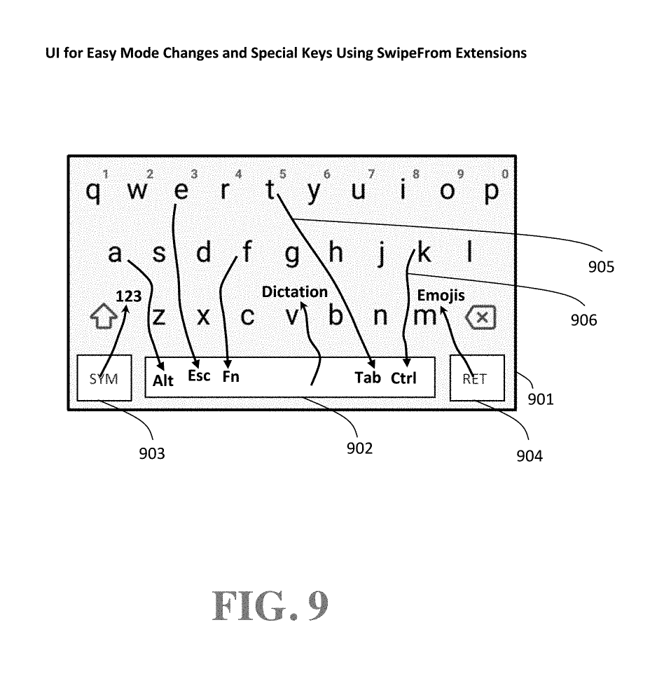

Next, the present application discusses the keyboard UI for mode changes and special keys of a keyboard. As seen in FIG. 9, a single SwipeFrom gesture, albeit from different source keys, is used for all mode changes including digits, emojis, and dictation. Thus, a swipe from SYM 903 changes the keyboard's mode to digit input (represented as “123”), swipe from RET 904 changes mode to emojis (represented as “Emoji”; and the mode is changed to dictation when user swipes from the spacebar 902. Further, instead of dedicating separate keys for special keys, the SwipeFrom UI is simply extended by mapping the source-key of the SwipeFrom gesture to the 1st letter of the label of the special-key. For example, as shown in FIG. 9, the Tab key is executed when a user swipes from the letter “T” (which is 1st letter of the label “Tab”) to the spacebar (as represented by reference numeral 905); the actual trace of the swipe is ignored. Further, to account for ambiguous swiping (so as to enable faster special-key execution) it is proposed that swipes originating from neighboring keys are mapped to the same special-key. For example Tab can also be inserted by swiping from R or Y keys (neighbors of T key) to the spacebar. Also observe in FIG. 9 that the special-keys are chosen so that there is enough distance between the key(s) along and its neighboring key(s). For example instead of having the key C for CTRL, a swipe is initiated from the key K (represented as 906) because K is farther away from F compared to C. In FIG. 9, it is shown that all the typical special-keys of a keyboard including Esc, Tab, Alt, Fn, and Ctrl may be implemented so that the full-keyboard experience may be brought to just one mobile screen. Those skilled in the art will appreciate that other letter assignments are possible to implement these special-keys and also these SwipeFrom extensions can be used for actions other than special-keys on a keyboard.

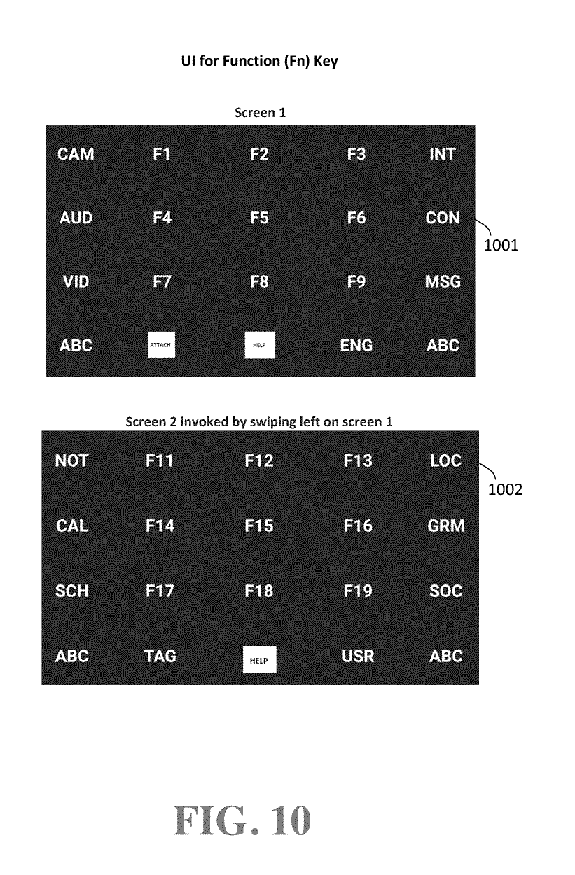

FIG. 10 illustrates one embodiment of keyboard UI for Fn key. Observe that F1 to F9 are located in one screen as shown in 1001 while F11 to F19 are in a second screen 1002; the second screen 1002 can be invoked by swiping left on the first screen 1001. Also observe that the keys to the left and right of the F1, F2 . . . keys in screen 1 are mapped to camera, audio, video, image, vocoder, and animation keys. Further, keys for attach, help, and language-selection are located on the bottom row of the screen. Those skilled in art will recognize that the proposed keyboard UI may be implemented using different designs and layouts for the Fn and their associated screen keys. For example the user may swipe on the keys staying in the same screen as in swipe F1-F3-F4 for F134.

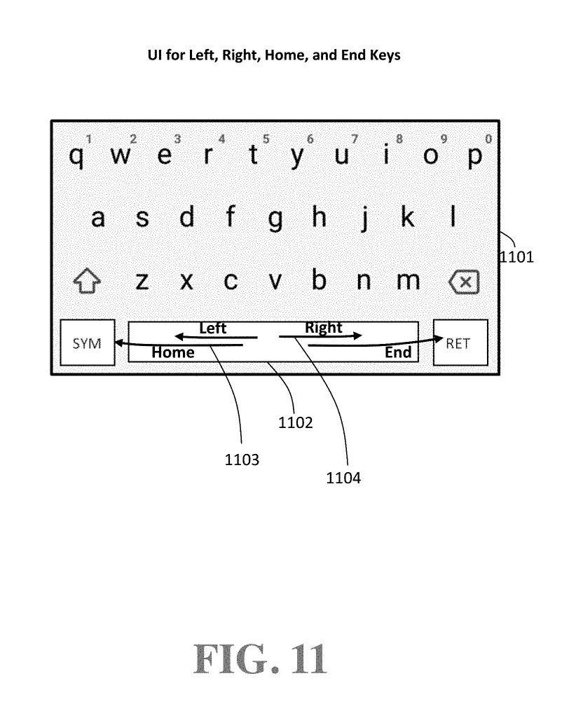

FIG. 11 illustrates one embodiment of a keyboard UI for Left, Right, Home, and End keys for keyboard 1101. Those skilled in art will recognize that the extra-wide spacebar 1102 is especially useful to realize this keyboard UI. While the left and right keys are simply swipe gestures on the spacebar to the left and right respectively, the Home 1103 and End 1104 swipes are executed using swipe gestures from spacebar 1102 to SYM key and from spacebar 1102 to RET key respectively. Those skilled in art will recognize that the proposed invention creates an intuitive keyboard UI for direction keys. Those familiar with art will further recognize that this keyboard UI is considerably different compared to keyboard UI that implements cursor control in some existing touch keyboards. For example, in the present keyboard UI, Left, Right, Home, End swipes enable reliable and fast positioning of a cursor to the left, right, home or end; as opposed to cursor control which implements a track pad action and not directional keys. Two examples are now considered to clearly illustrate the use of the proposed invention: 1) a user intending to position the cursor to the left of its current location could simply and blindly swipe left on spacebar, as opposed to using the cursor control and eye-balling it; and 2) if the user intends to position cursor between two words then the user could touch somewhere in that vicinity and then use left/right gestures for precise positioning.

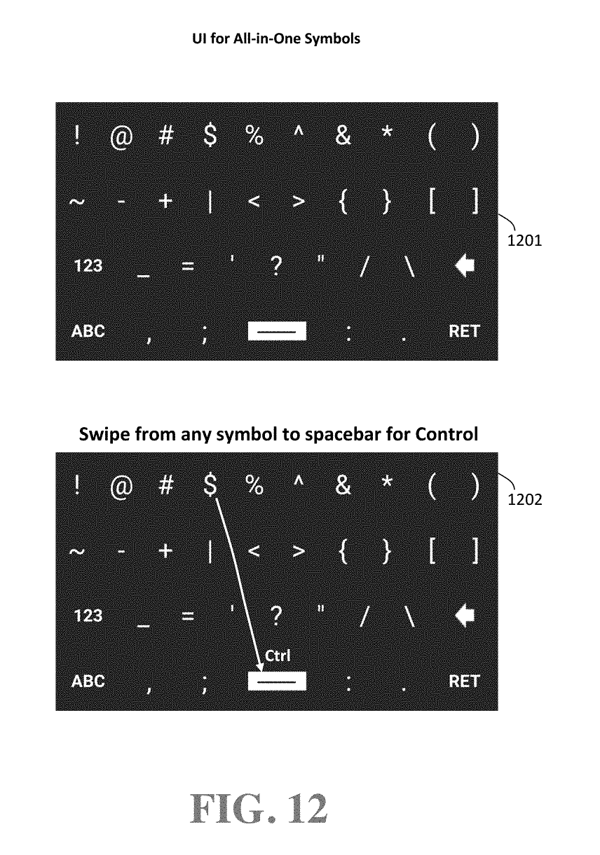

FIG. 12 shows an embodiment of a keyboard UI for including all 31 symbols in one screen 1201. Additionally, a CTRL can be implemented as before by swiping from any symbol key to the spacebar as shown on screen 1202.

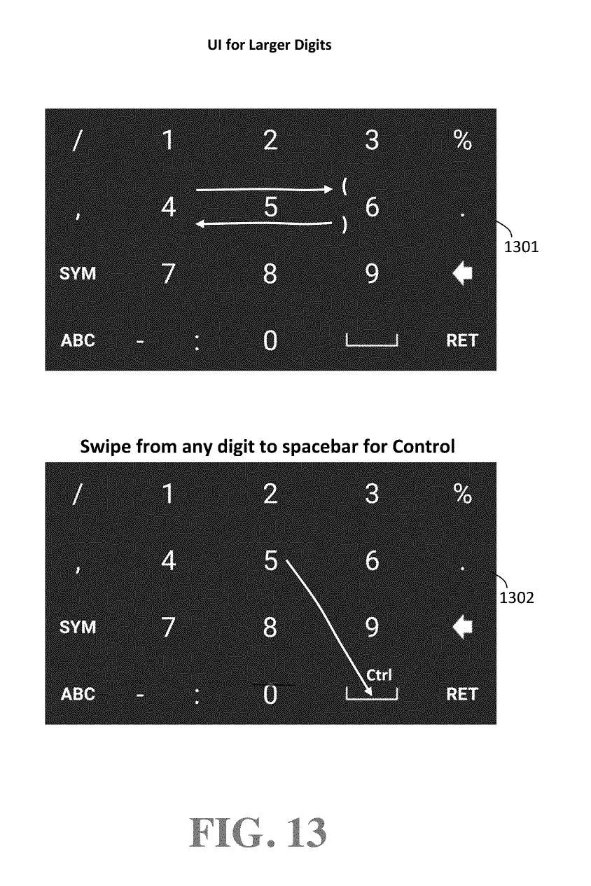

FIG. 13 shows an embodiment of a keyboard UI for incorporating larger size digits in the digits screen. Those familiar with art will recognize that both of these UIs are possible because of the SwipeFrom gesture used for mode changes that enabled the separation of symbols and digits modes. Further, in FIG. 13, observe that the digits screen 1301 also includes several symbols which are typically used in the digits context. For example telephone numbers are usually accompanied by a “dash” or a “comma” or a “period” so these symbols are included in the digits screen. Also, right and left gestures in digits screen have been added for inserting an open-bracket and close-bracket respectively. Finally, observe that in the digits screen 1302, the SwipeFrom gesture is used to implement the CTRL key as well.

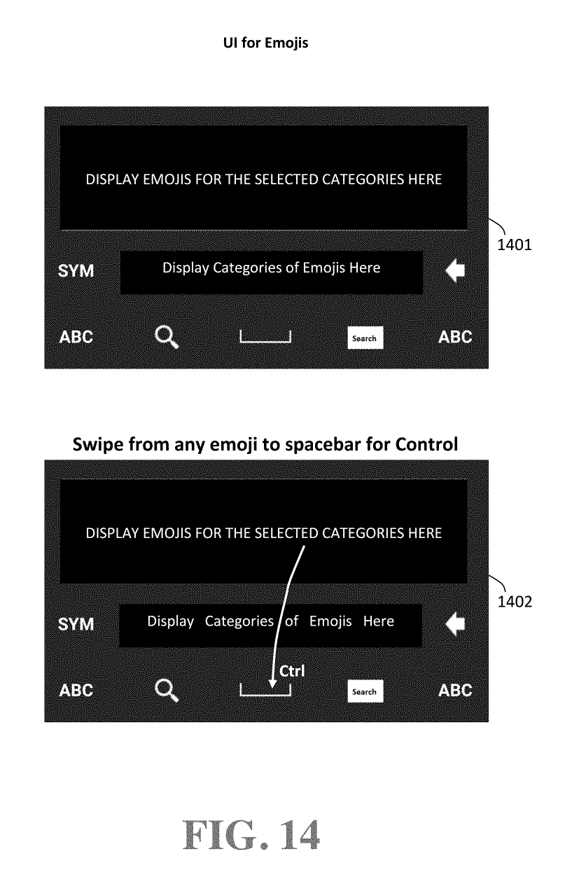

FIG. 14 illustrates one embodiment of keyboard UI for a better emoji screen 1401. Observe that the SYM and DEL keys are at the same location as they are in other screens making the keyboard UI consistent across modes. Also, in the emoji UI, the right ABC key's label changes to RET when an emoji key is pressed; thus making the RET key location also consistent with other screens. To further keep the UI consistent across screens, the swipe gesture from ABC key changes screen to correspond to the mode from where the current mode screen was invoked. For example, if the emoji mode is invoked by swiping from the RET key in the digits mode then swiping out from ABC key in emoji screen changes screen to digits mode. Finally, observe that in the emoji screen 1402, the SwipeFrom gesture is used to implement the CTRL key similar to all other mode screens.

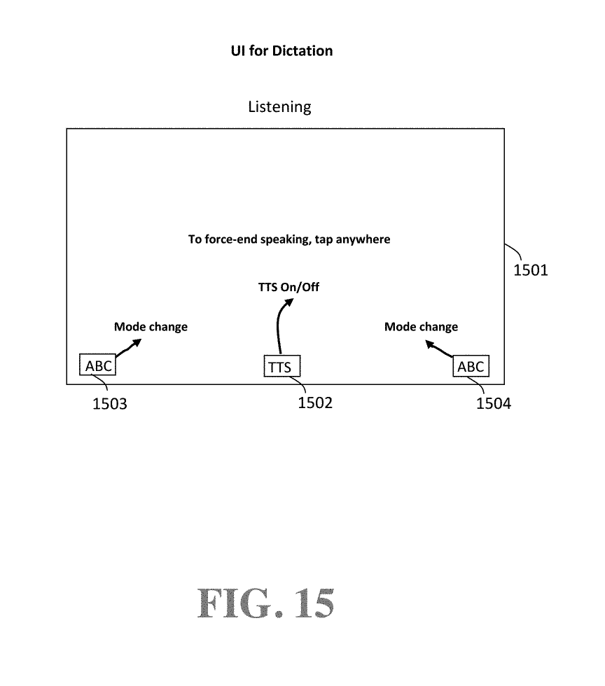

FIG. 15 illustrates one embodiment of a keyboard UI for dictation screen 1501. Observe that instead of a start/stop button in the middle of this screen that is seen in existing keyboard's dictation UI, in the proposed keyboard UI, ABC keys 1503 and 1504 are used so that the dictation mode is consistent with all other modes. Further observe that the dictation mode is in “always listening” mode and prints the speech-to-text output into the application window. However if in noisy situations, the user needs to manually indicate end of speaking then this could be done by simply tapping anywhere on the screen. Like all other modes, SwipeFrom ABC changes mode to the mode that called the dictation mode. Finally, another new aspect of this proposed keyboard UI is that a TTS (text-to-speech) key 1502 is overlaid onto the dictation screen which may be used by users to play back the speech that was recognized. Observer that a swipeFrom is used to turn TTS on/off because that way the user does not falsely trigger TTS when tapping screen 1501 especially in eyes-free mode like while driving.

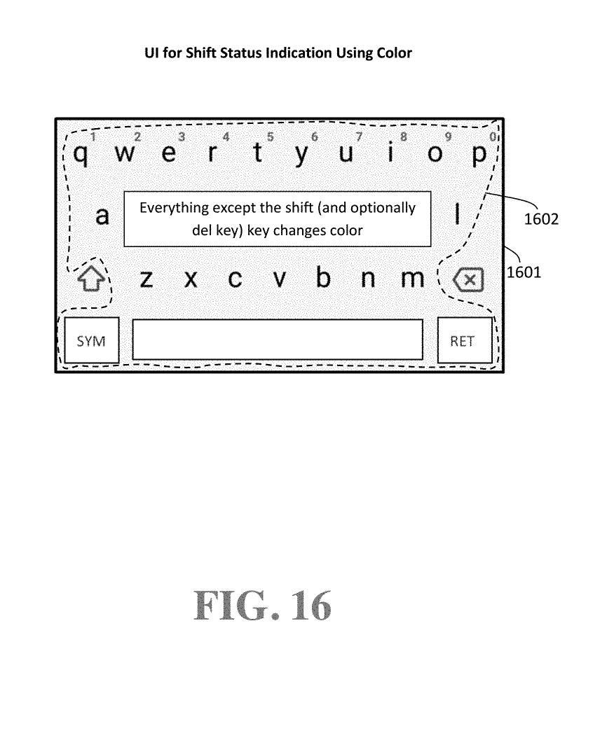

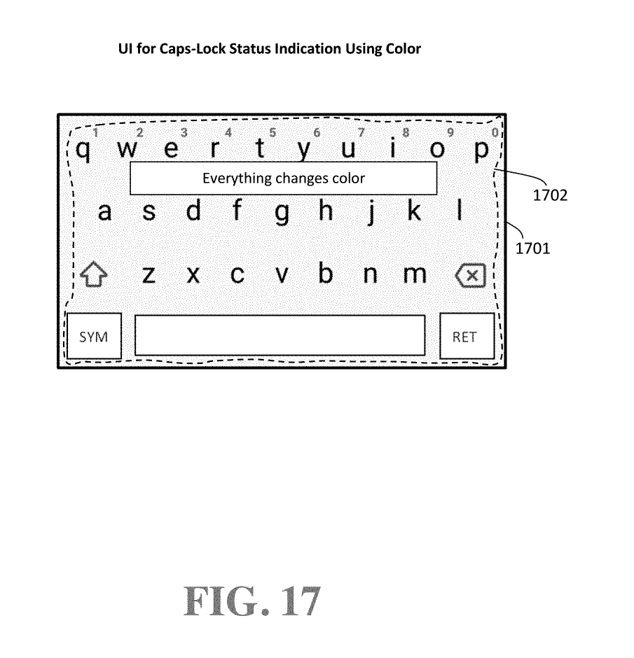

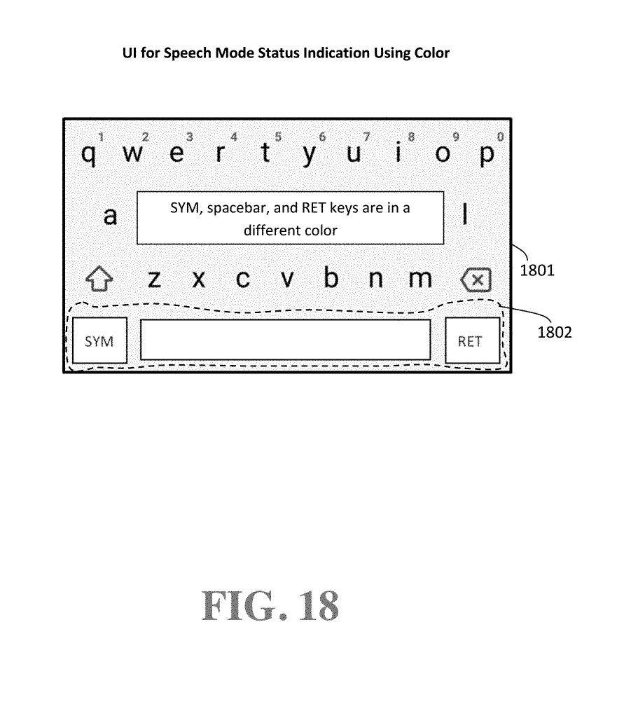

FIG. 16 illustrates one embodiment of keyboard UI when the shift key of the keyboard 1601 is pressed. Observe that all the keys, excluding the Shift and Del keys, as shown by 1602, change shade/color. In contrast, as shown in FIG. 17, when the caps-lock is pressed (either by double-tapping or long-pressing the shift key) then all the keys as shown by 1702 change color or change shade of their existing color. The proposed keyboard UI for shift and caps-lock status indication is better because when typing fast, it is much easier for human brain to register color changes over a wide area compared to color changes of a single key or change in keys' letters' case that are used in existing keyboard UIs. As shown in FIG. 18, changing color of keys of the keyboard 1801 can also be used to indicate status of speech recognition features. For example, the color of all letter keys are in a different color, compared to color of SYM, RET, and spacebar shown in 1802, to indicate that these keys are not mapped to any speech recognition function.

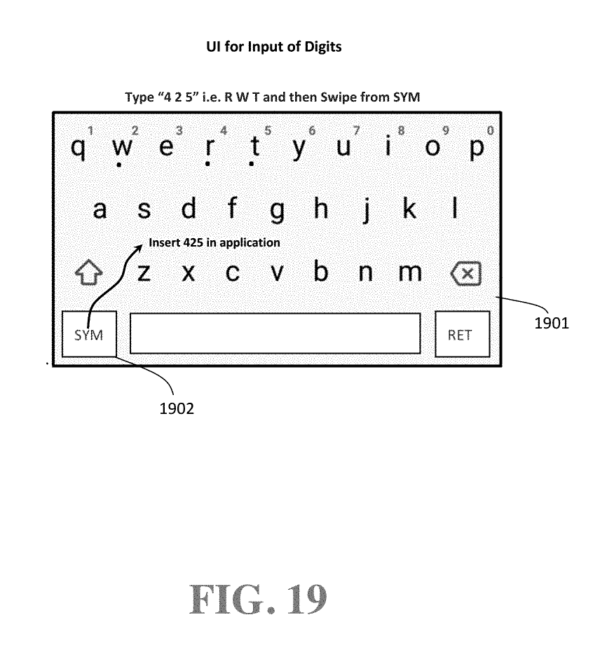

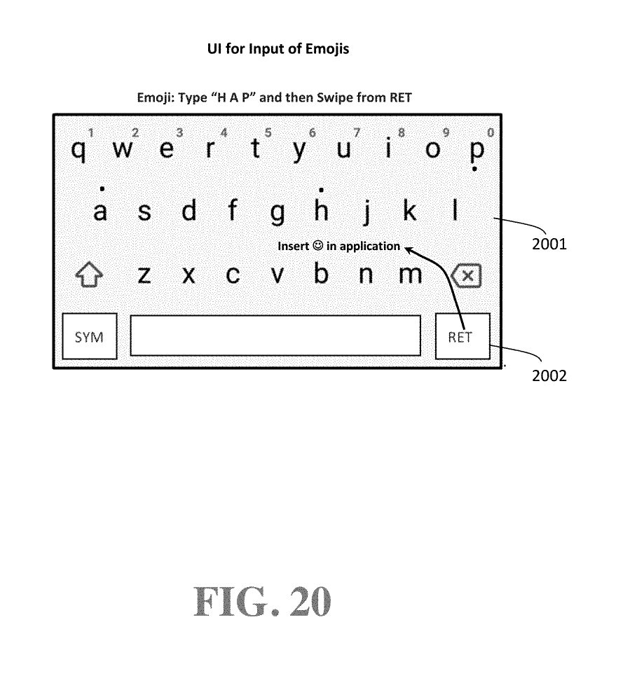

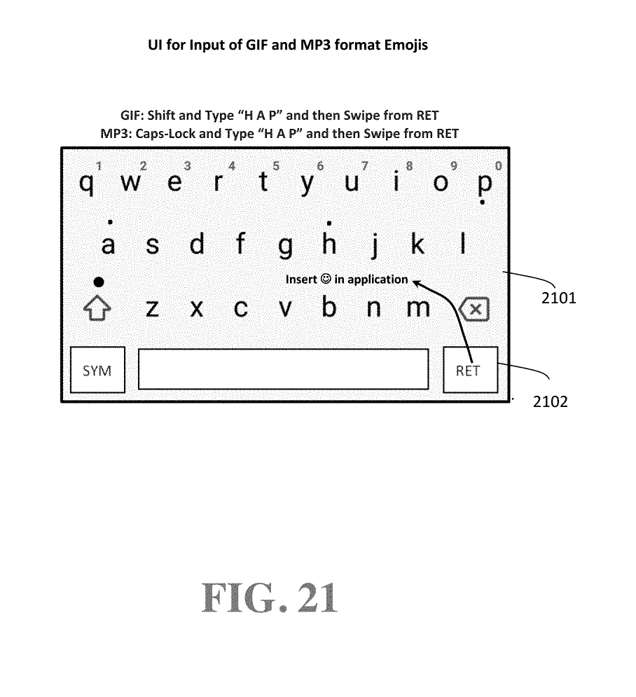

In FIGS. 19 to 23, the SwipeFrom feature discussed earlier is used to auto-predict digits and emojis. Specifically, if a user types letters immediately before using the SwipeFrom gesture originating from sym/ret, then the keyboard uses those letters to predict digits/emojis and inserts the result into the application without actually changing modes. For example, as shown in FIG. 9, if a user simply swipes from SYM then the keyboard changes mode to digits. However as shown in FIG. 19 if the user types letters R W T corresponding to digits 4 2 5 on keyboard 1901 and then swipes from SYM 1902 then the keyboard directly inserts 425 in the application. As another example, as shown in FIG. 9, if the user swipes from RET the keyboard changes mode to emojis, but if the user types H A P and then swipes from RET 2002 then the keyboard 2001 predicts an emoji using H A P as the starting letters and inserts the result [symbol] directly into the application as illustrated by FIG. 20. FIG. 21 is a similar example but with a slightly advanced keyboard UI. Here, the user presses the shift/caps-lock key first, then types letters H A P, then swipes from RET 2102. In this case the keyboard 2101 notices the shift key status and instead of inserting the predicted emoji, it inserts a GIF/MP3 format version of the predicted emoji.

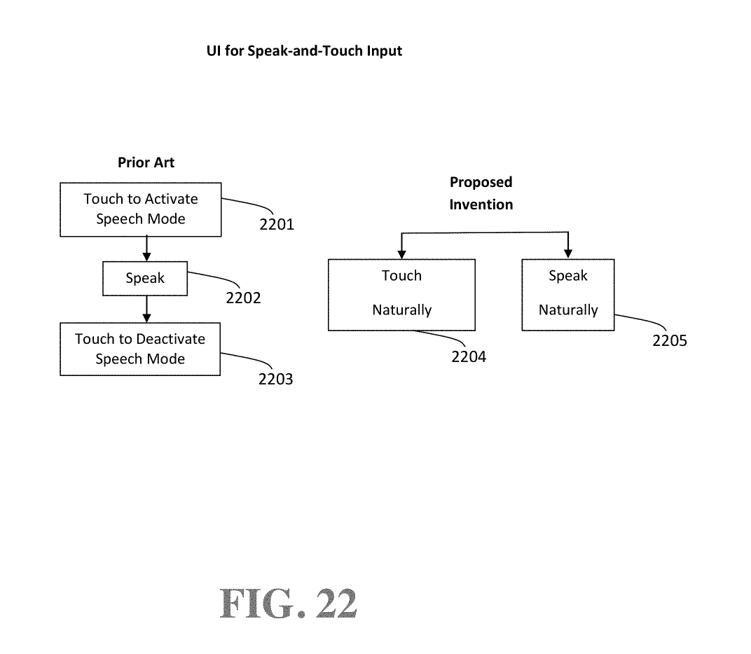

In FIG. 22 the existing keyboard UIs for speech input are contrasted with the proposed keyboard UI. Observe that in prior art keyboard UIs, activation 2201 and deactivation 2203 of speech mode 2202 are needed. The activations are either done manually (by asking users to tap a key) or automatically (by asking users to speak a key-word phrase) or using a combination of the two. For example, consider the simple example of using voice assistant to search the internet. The user has to tap a voice-button or say a key-word like “Ok Assistant” to activate the voice mode. After finishing speaking the user can optionally tap a Stop-key or say “Done” or have the speech automatically detect end of speech. The proposed keyboard UI departs from using this start/stop mechanism to activate/deactivate speech modes. Instead, in accordance with the present keyboard UI, the user simply speaks naturally as indicated by 2205 and touches as indicated by 2204 without any pre-determined ordering of the two inputs. The proposed keyboard UI uses built-in algorithms that couple the timings and context of events. Example: user speaks a search phrase and at anytime during or before or after speaking the user touches (taps or long-presses) the search button.

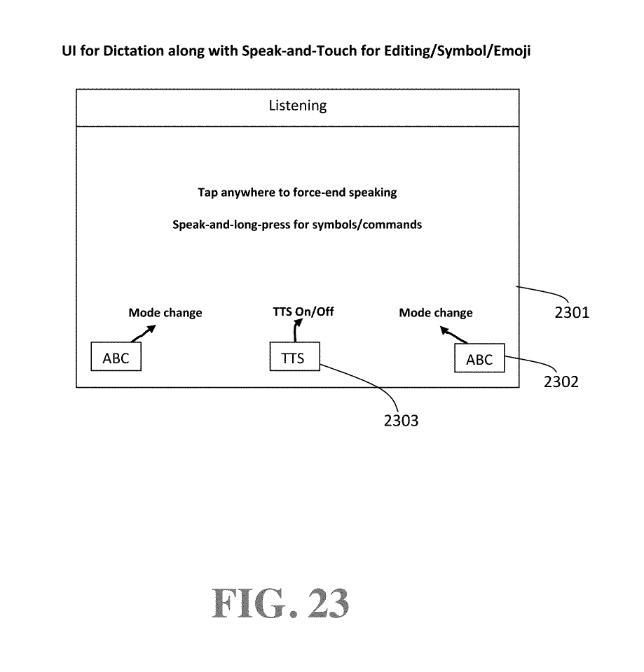

In FIG. 23, a dictation UI similar to the one shown in FIG. 15 is shown, but with the exception that this keyboard UI is further enhanced by a speak-and-touch UI. Observe that if the user wants to dictate, the user can simply keep speaking, however, if the user wants to explicitly input a symbol or issue an edit command (e.g. delete <word>) then the user could speak-and-long-press on the dictation screen 2301. For instance, consider an example wherein the user wants to dictate the phrase “The weather in San Francisco is raining [symbol] but it's getting better by evening [symbol] ”. If the user were to simply dictate this using existing UIs, the output becomes ambiguous and may end up being “The weather in San Francisco is raining sad but it's getting better by evening happy”. In contrast if the user, using the proposed keyboard UI, were to dictate “The weather in San Francisco is raining”, then use speak “sad” while long-pressing the screen 2301, then dictate “it's getting better by evening”, then speak “happy” while long-pressing the screen 2301, then there is no ambiguity in output; the keyboard UI will insert symbols/emojis for sad and happy. Those familiar with art will recognize that this is an extremely useful feature because it essentially enables a 100% task-completion-rate for the user. The mode changes 2302 and TTS 2303 are similar to those in FIG. 15.

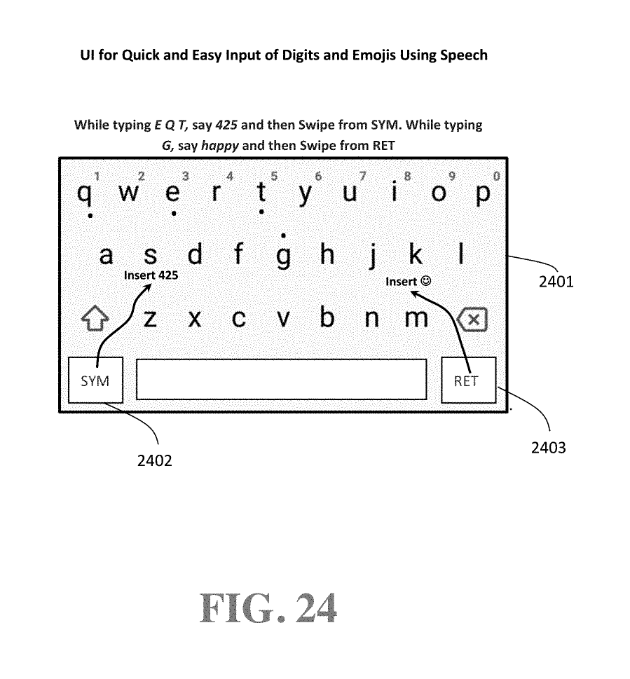

The input of digits in FIG. 24 is similar to in FIG. 19 but with the main difference being that here the user speaks and types digits, instead of only typing, immediately before using swiping from SYM. In this case the keyboard 2401 uses the user's speech plus the ambiguously typed letters E Q T, and the SwipeFrom SYM 2402 as an indication of digit prediction, and then predicts 425 and inserts that into the application. The emoji input in FIG. 24 is similar to FIG. 20 but with the main difference being that here the user speaks and types emojis, instead of only typing, immediately before using swiping from RET. In this case the keyboard 2401 uses the user's speech plus the ambiguously typed letter G, and the SwipeFrom RET 2403 as an indication of emoji prediction, and then predicts [symbol] and inserts that into the application.

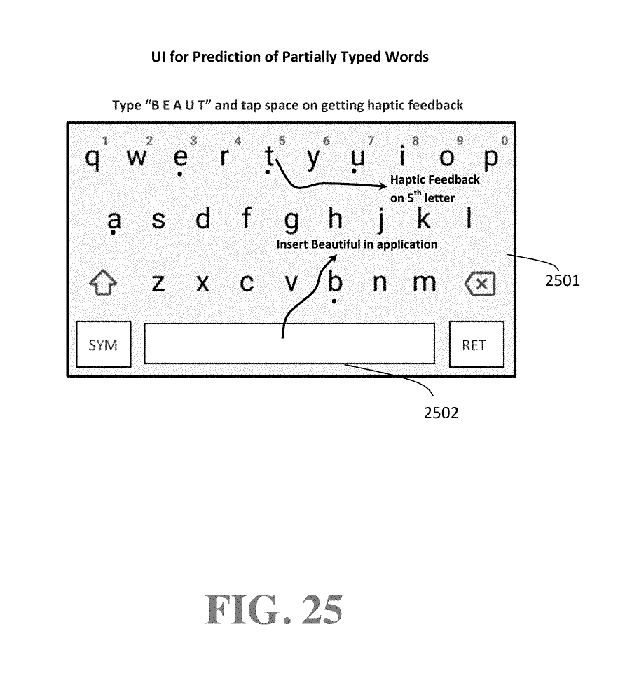

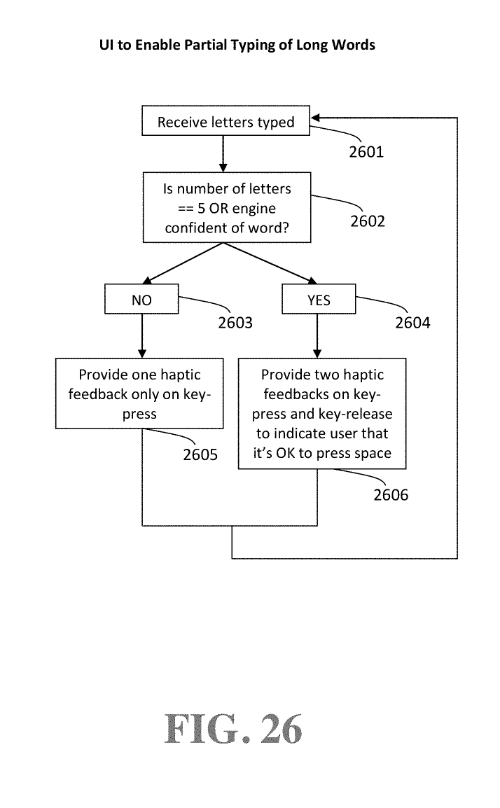

FIG. 25 illustrates one embodiment of a keyboard UI to enable users to partially type long words. The basic idea is to give users a feedback that the auto-correction engine is confident about completing the user's partially typed word. The feedback itself could be something that does not require the user to disrupt the flow of typing. For example, as shown in FIG. 25, when the keyboard 2501 gives feedback mid-way through the user's typing using a slightly different haptic e.g. double haptic; at this moment the user has the option to hit space 2502 and thus have the system auto-compete the word. Two examples are shown in 2500, one for typing words and the other for inputting emojis. An algorithm for doing this is shown in FIG. 26. The letters typed by the user are received at block 2601. The method checks if the number of letters are equal to some pre-set value (e.g., 5) shown in block 2602 . . . if the number of letters typed are not equal to 5 as determined in block 2603 then as shown in block 2605 the system provides just one haptic feedback on key-press. Otherwise, block 2603 indicates to block 2606 to send two haptic feedbacks. Since the user is receiving two haptic feedbacks post a single, the user knows that it is okay to press the space-bar and have the confident system output the predicted choice into the application. Those familiar with art will recognize that several variants of this keyboard UI may be used. For instance, when the engine is confident of prediction, two haptics may be provided and then all haptic feedback may be stopped; or haptic may be stopped when the engine is confident and then double haptic may be used for all extra letters that user types; tone may be played when engine is confident and the like.

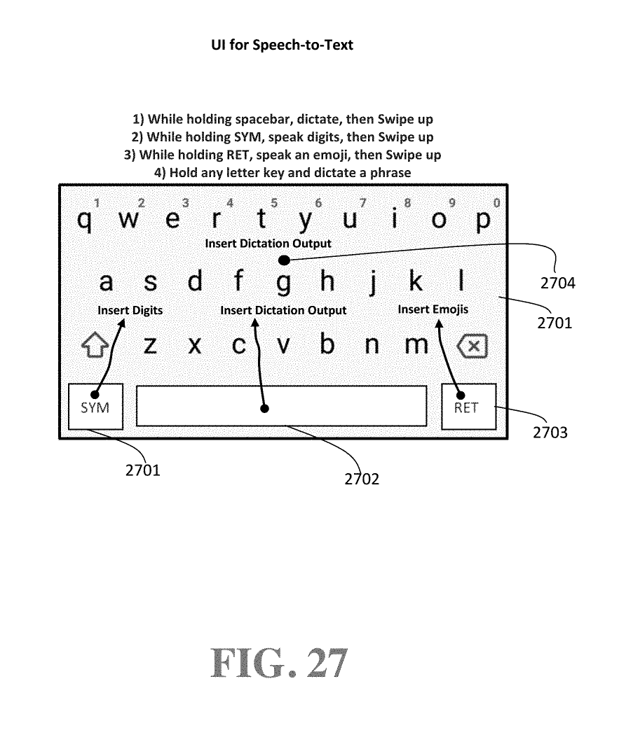

FIG. 27 illustrates one embodiment of a keyboard UI for speech-to-text, wherein the user long-presses the SYM key 2701 or the spacebar 2702 or the RET key 2703, while speaking a symbol/phrase/emoji and then swipes away from the long-pressed key (2701 or 2702 or 2703). The long-press+SwipeFrom combination is used by the keyboard to switch to symbol/dictation/emoji speech-to-text mode. Another option is for the user to hold any letter key while dictating as shown in 2704 and upon releasing the key, the entire recognized text is displayed into the application. Those skilled in art will recognize that several variants of the proposed keyboard UI may envisioned, such as a long-press any key while speaking and release/swipe away. Another variant is a keyboard UI wherein the user taps letter key(s) while speaking an entire phrase and then swipes away; and the keyboard uses the letters typed as part of a phrase language mode for the recognizer; e.g. user types letters H A Y while speaking a phrase to suggest that the phrase spoken has three words and then have letters beginning with H, A, and Y.

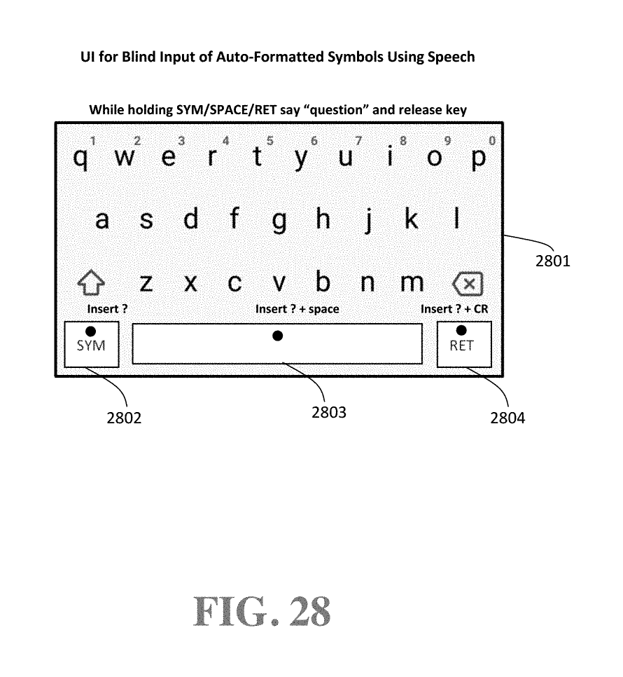

FIG. 28 illustrates an embodiment of keyboard UI for blind of symbols using speech. Here the user simply holds the SYM 2802 or spacebar 2803 or the RET key 2804 of the keyboard 2801 to speak symbols and releases after speaking (or after a preset time of long-press). When the SYM 2802 key is used, the keyboard inserts the recognized symbol without a space; on using the spacebar a space is inserted after the recognized symbol; and when user speaks-and-holds the RET key 2804 the keyboard 2801 inserts a carriage return after the recognized symbol.

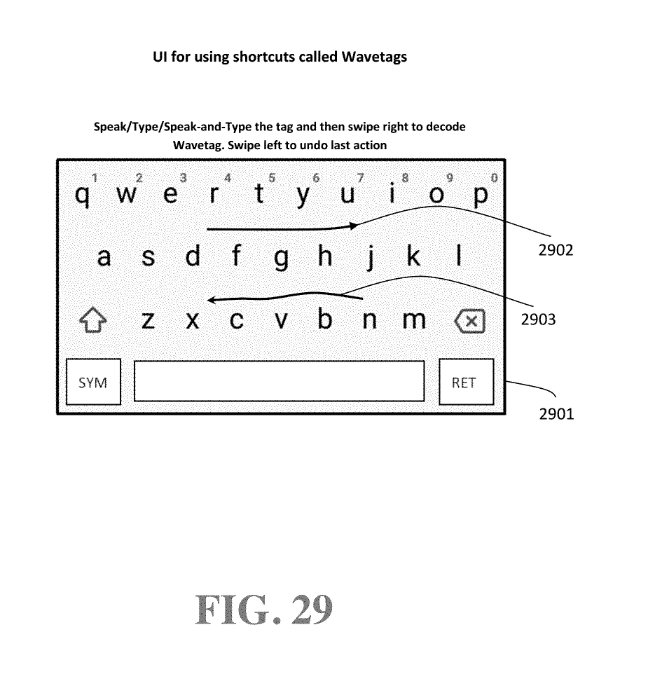

FIG. 29 illustrates one embodiment of keyboard UI for blind input of shortcuts referred to as Wavetags. Wavetags are tags associated with any object or set of actions which when called using an action like a swipe gesture, inserts that object or carries out the tagged actions. For example, a phrase “I am on my way, I will see you in 5” may have been assigned a tag which is say “onMyWay5”. Instead of having to remember this tag and then typing it out and then selecting the phrase from the choice list, the user can use Wavetags and simply say “on my way 5” or “way 5” or “my way 5” and swipe right on anywhere on the letter keys as indicated by 2902 of the keyboard 2901. The keyboard 2901 then inputs the entire phrase directly into the application. The action may be undone using the swipe-left gesture indicated by 2903.

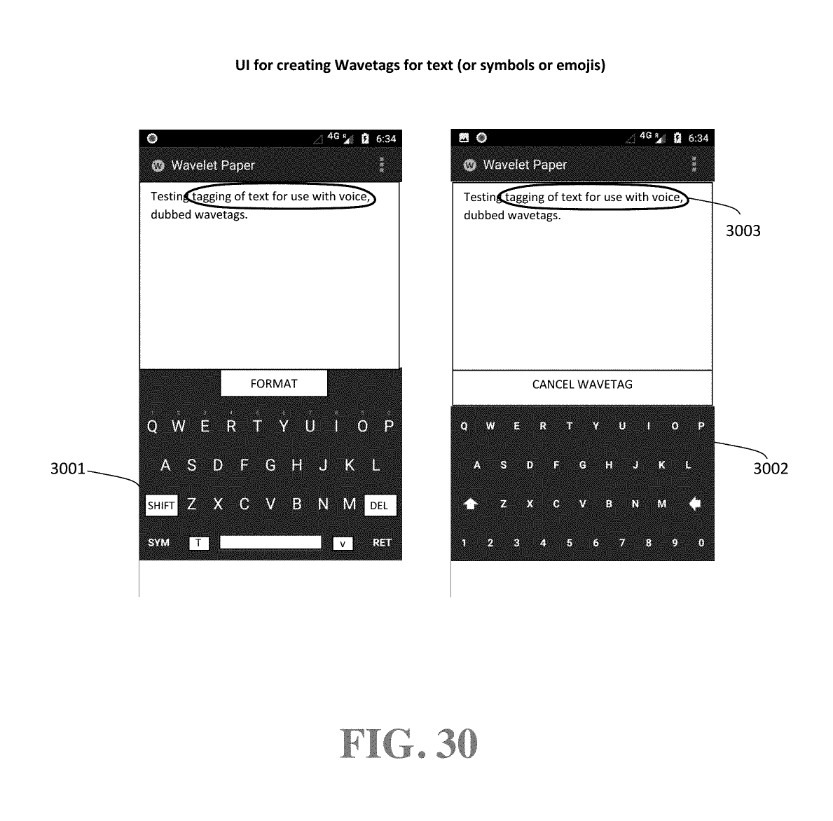

FIG. 30 illustrates one embodiment of keyboard UI for creating Wavetags for text. Observe that when text is selected, two keys on the left and right of the spacebar of keyboard 3001 pop up. These keys are used to begin the Wavetag tagging steps. Observe that on pressing these keys, the keyboard changes its theme to that shown in FIG. 3002. The user may change the selection of text shown in 3003 and when the text to be tagged is finalized, the user simply types a tag-word and confirms it by tapping the same displayed on the top-left of the keyboard; the user may cancel the tagging process by tapping the “cancel wavetag” key displayed on the keyboard's top-right. Those skilled in art will recognize that the same keyboard UI may be extended for creating Wavetags for symbols or emojis. For example for tagging emojis, user can long-press an emoji in the emoji screen to get the qwerty screen with Wavetag option as shown in FIG. 28.

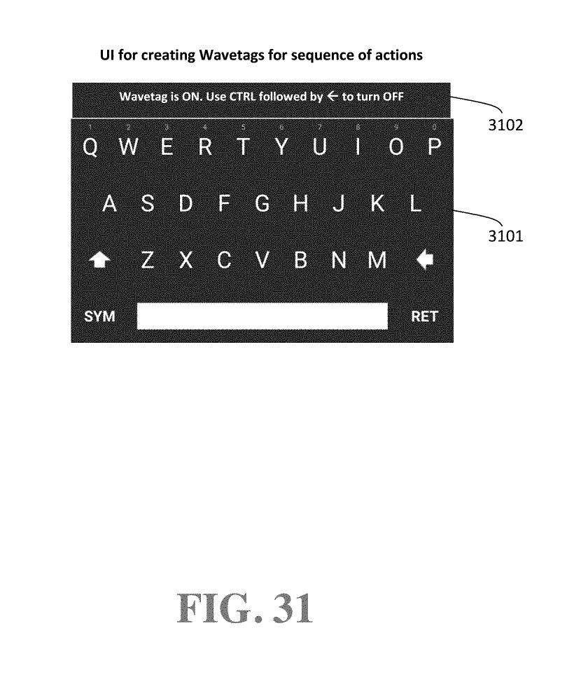

FIG. 31 illustrates an embodiment of keyboard UI for creating Wavetags for a sequence of actions. To begin Wavetag the user uses CTRL followed by a swipe right action. As show in FIG. 31, all actions of the user are now being recorded so they could be tagged. When an entire sequence of one or more actions are done, the user uses CTRL followed by left swipe ← as shown at 3102 to indicate that all these actions need to be tagged; the keyboard 3101 then goes back to the tagging state as shown in FIG. 30.

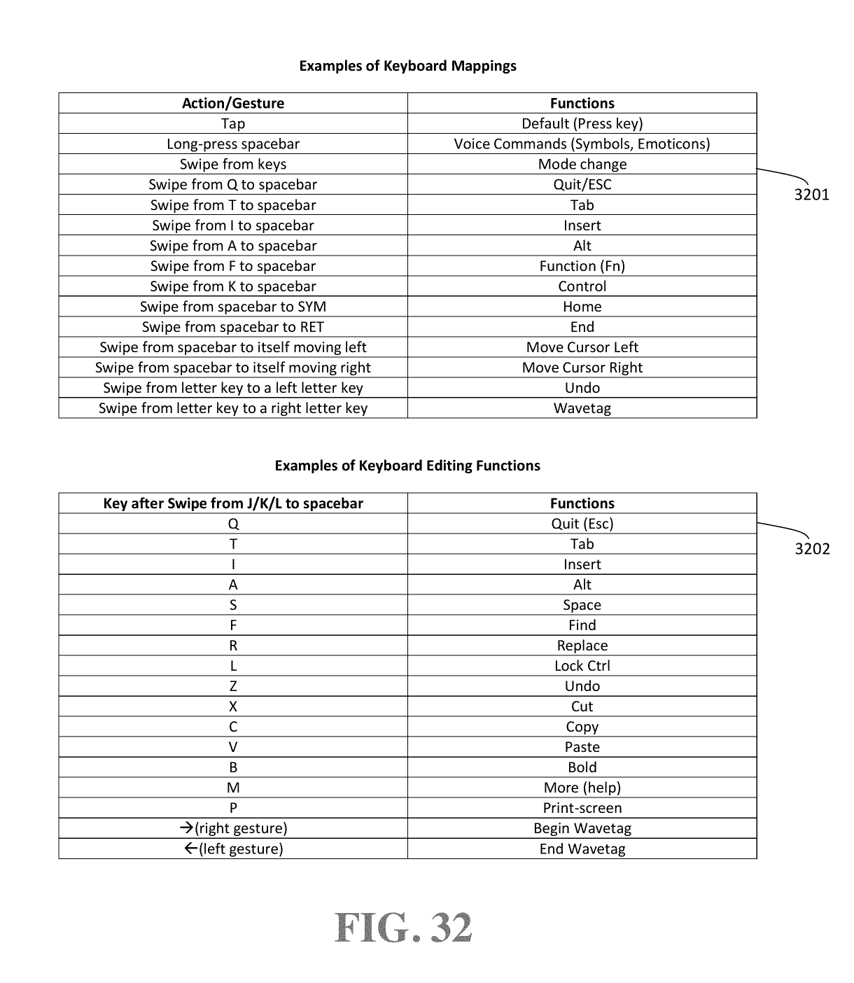

FIG. 32 illustrates one embodiment of keyboard function mappings 3201 and keyboard editing commands 3202; other types of assignments are possible.

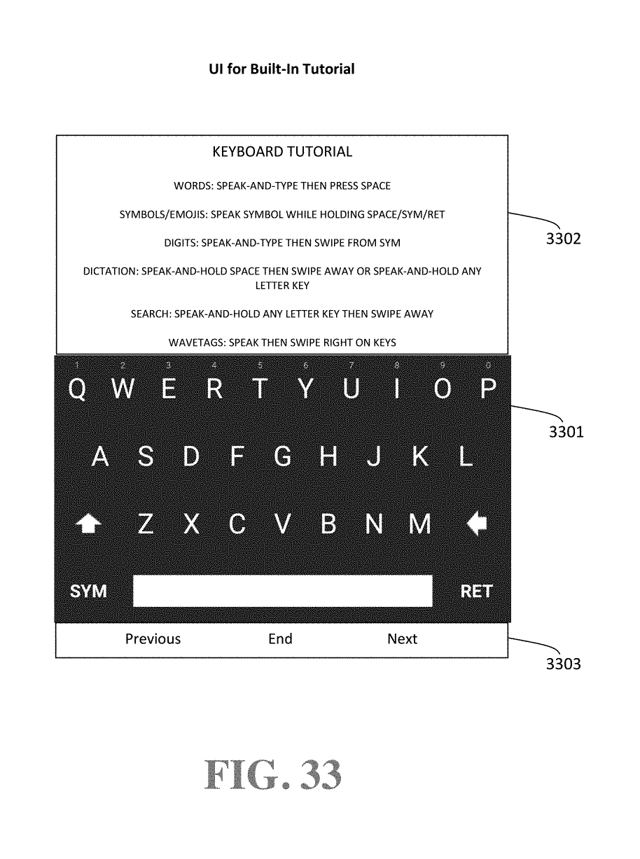

FIG. 33 illustrates one embodiment of a keyboard UI for implementing a tutorial 3302 within the keyboard 3301. Observe that the keyboard UI is such that everything about the actual keyboard is maintained to be the same and an additional row of buttons for learning the functionalities 3303 is added. At each stage of the tutorial, a notification appears indicating the tutorial's task and instructions. Once done, there is a seamless transition from the tutorial to using the actual keyboard.

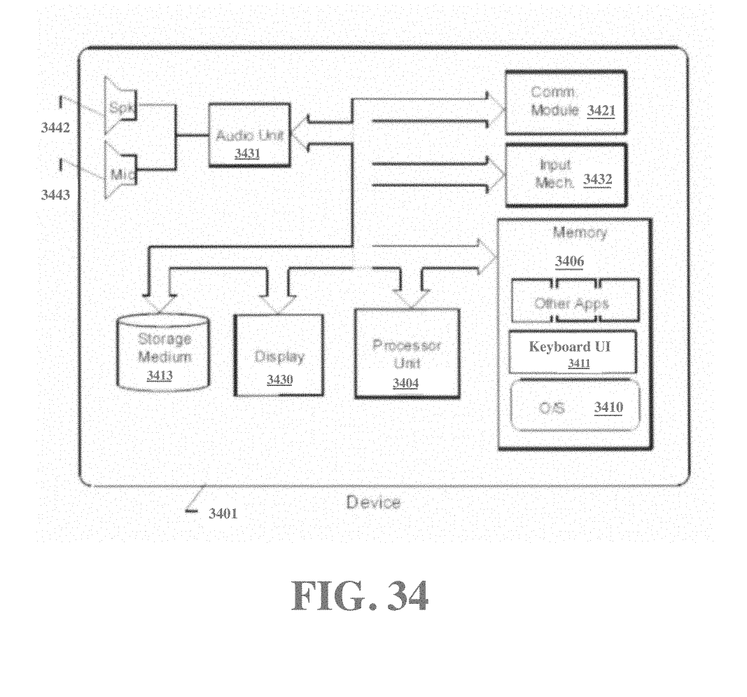

FIG. 34 is a functional block diagram representing a computing device for use in certain implementations of the disclosed embodiments or other embodiments of the present keyboard user-interface. The mobile device 3401 may be any handheld computing device and not just a cellular phone. For instance, the mobile device 3401 could also be a mobile messaging device, a personal digital assistant, a portable music player, a global positioning satellite (GPS) device, or the like.

In this example, the mobile device 3401 includes a processor unit 3404, a memory 3406, a storage medium 3413, an audio unit 3431, an input mechanism 3432, and a display 3430. The processor unit 3404 advantageously includes a microprocessor or a special purpose processor such as a digital signal processor (DSP), but may in the alternative be any conventional form of processor, controller, microcontroller, state machine, or the like.

The processor unit 3404 is coupled to the memory 3406, which is advantageously implemented as RAM memory holding software instructions that are executed by the processor unit 3404. In this embodiment, the software instructions stored in the memory 3406 include a keyboard user-interface (UI) 3411, a runtime environment or operating system 3410, and one or more other applications 3412. The memory 3406 may be on-board RAM, or the processor unit 3404 and the memory 3406 could collectively reside in an ASIC. In an alternate embodiment, the memory 3406 could be composed of firmware or flash memory. The memory 3406 may store the computer-readable instructions associated with the keyboard UI 3411 to perform the actions as described in the present application.

The storage medium 3413 may be implemented as any nonvolatile memory, such as ROM memory, flash memory, or a magnetic disk drive, just to name a few. The storage medium 3413 could also be implemented as a combination of those or other technologies, such as a magnetic disk drive with cache (RAM) memory, or the like. In this particular embodiment, the storage medium 3413 is used to store data during periods when the mobile device 3401 is powered off or without power. The storage medium 3413 could be used to store contact information, images, call announcements such as ringtones, and the like.

The mobile device 3401 also includes a communications module 3421 that enables bi-directional communication between the mobile device 3401 and one or more other computing devices. The communications module 3421 may include components to enable RF or other wireless communications, such as a cellular telephone network, Bluetooth connection, wireless local area network, or perhaps a wireless wide area network. Alternatively, the communications module 3421 may include components to enable land line or hard wired network communications, such as an Ethernet connection, RJ-11 connection, universal serial bus connection, IEEE 1394 (Firewire) connection, or the like. These are intended as non-exhaustive lists and many other alternatives are possible.

The audio unit 3431 is a component of the mobile device 3401 that is configured to convert signals between analog and digital format. The audio unit 3431 is used by the mobile device 3401 to output sound using a speaker 3442 and to receive input signals from a microphone 3443. The speaker 3432 could also be used to announce incoming calls.

A display 3430 is used to output data or information in a graphical form. The 3430 display could be any form of display technology, such as LCD, LED, OLED, or the like. The input mechanism 3432 may be any input mechanism. Alternatively, the input mechanism 3432 could be incorporated with the display 3430, such as the case with a touch-sensitive display device. The input mechanism 3432 may also support other input modes, such as lip tracking, eye tracking, thought tracking as described above in the present application. Other alternatives too numerous to mention are also possible.

Those familiar with art will recognize that several extensions of the many UIs proposed in this application are possible. As an example, a dedicated button may be assigned to global speech commands, which may be used in applications like search, excel, charts, email composition etc. As another example, input of digits/emojis (using touch or speak-and-touch) and using SwipeFrom can be extended such that users can input symbol/emoji along with a comma/period, by tracing an arc starting at sym/ret key, continuing over letter keys, and ending onto the left/right end of the spacebar.

The claimed invention is:

1. A system having keyboard user-interface (UI), comprising:
a modified keyboard having fewer keys than a standard qwerty keyboard, the modified keyboard appearing on a display of the system; and
a keyboard UI module for processing inputs from the modified keyboard, wherein the keyboard UI module implements directional double taps for specified symbols, swipe gestures for changing modes that are displayed as the modified keyboard and for incorporating special keys of the modified keyboard, and status indicator changes using color coding schemes on the display.

2. A method for implementing a keyboard user-interface (UI), comprising:
computer-readable instructions that implement a directional double tap for specified symbols;
computer-readable instructions that implement a swipe gesture for changing modes that are displayed as the keyboard UI;
computer-readable instructions that implement another swipe gesture for incorporating special keys of the keyboard UI; and
computer-readable instructions that implement a status indicator change using color coding schemes for the keyboard UI.

3. A method for implementing a keyboard user-interface (UI), further comprising:
computer-readable instructions that implement wavetags for blind input of symbols and shortcuts.
